(19) United States
(12) Patent Application Publication
(10) Pub. No.: US 2008/0125920 A1
(43) Pub. Date: May 29, 2008

(54) Unmanned Airborne Vehicle For Geophysical Surveying

(75) Inventors: Philip John Miles, Oakville (CA); Richard Thomas Partner, Ontario (CA); Kenneth Ronald Keeler, Ontario (CA); Terence James McConnell, Ontario (CA)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Fugro Aiirborne Surveys Corporation, Mississauga (CA)

(21) Appl. No.: 11/576,590

(22) PCT Filed: Oct. 11, 2005
(86) PCT No.: PCT/CA05/01557

§ 371 Date: Oct. 26, 2007

(30) Foreign Application Priority Data
Oct. 8, 2004 (CA) 2484,422

(51) Int. Cl. G05D 1/04; G01C 23/00; G01V 3/165; B64C 39/02; G01V 3/40; G06F 19/00

(52) U.S. Cl. 701/2; 701/3; 701/15; 701/16; 701/4

(57) ABSTRACT

An un-manned airborne vehicle (UAV), for acquiring aeromagnetic data for geophysical surveying at low altitude on land or over water, comprising an extended fuselage that is adapted to hold and maintain magnetometer and a magnetic compensation magnetometer at a minimum distance from the avionics and propulsion systems of the UAV. The magnetometer measures magnetic anomalies and the magnetic compensation magnetometer measures magnetic responses corresponding to the pitch, yaw and roll of the UAV. A data acquisition system stores and removes the magnetic response measurements from the magnetic anomaly measurements. The data acquisition system also stores a survey flight plan and transmits the same to the avionics system. The generator of the UAV is shielded and the propulsion system is stabilized to reduce magnetic and vibrational noises that can interfere with the operation of the magnetometer.

### FIELD OF THE INVENTION

The present invention relates to a system and a method for acquiring aeromagnetic data. More particularly, the present invention relates to an autonomous unmanned airborne vehicle (UAV) for acquiring aeromagnetic data for geophysical surveying.

### BACKGROUND OF THE INVENTION

In the mineral and petroleum exploration industries, there is an ongoing effort to identify new regions of geological interest. Frequently, geophysical techniques are employed to identify these regions, which may be at tremendous depths beneath the earth's surface or even under the ocean floor.

One promising geophysical technology is magnetic anomaly detection, which uses sensitive magnetometers to detect small changes in residual magnetism that may indicate regions of geophysical significance or anomalies that are at tremendous depths, separated by rock and/or water. A difficulty with this technology is that, at the sensitivities that magnetometers must operate to detect returns from the area under investigation, metal components and electrical and magnetic fields generated by nearby equipment may interfere with the magnetometer readings.

Because of the often difficult terrain that must be traversed, usually under adverse conditions, as well as the vast dimensions of the area to be surveyed, airborne surveys have become of tremendous interest.

Current airborne surveying systems, such as those described in U.S. Pat. No. 6,255,825, have geophysical sensor suites, including magnetometers, that are either attached to or integrated with manned aircraft. These surveys are generally flown at a low but constant altitude of about 100 m and the ability to contour fly or “drape” is not required. Furthermore, such aircraft require large take-off and landing surfaces, which may limit the effective reach and range of such surveys. As well, with any manned flight, human factors such as fatigue, reflex times and the like must be taken into account.

Nevertheless, because of the weak returns often generated by the formations of interest, the tendency has been towards flying at lower and lower clearances above the ground, and in more remote and difficult access areas of the world. With each altitude reduction of a survey, or the more remote or difficult the access area, concerns with the safety of the operation of the conventional manned airborne survey increase exponentially. These safety risks are compounded when the survey crosses open water such as ocean or sea. As a result, many proposed airborne geophysical surveys have not been proceeded with or abandoned on the basis of unacceptable safety risk in order to achieve the desired survey sensitivity.

Over the past two decades there have been numerous, incremental improvements in aeromagnetic data quality and data processing techniques but nothing that could truly be classed as a significant leap so as to overcome the safety/performance imbalance. There is little or no sustainable product differentiation between service providers and competition is inevitably reduced to price. Low barriers to entry allow new competitors to continuously enter the market place—virtually guaranteeing an ongoing oversupply situation, driving prices ever further downward, constantly eroding market share and further compromising industry safety standards.

The sea has been recognized as one of the last frontiers on earth to be exploited for mineral and petroleum development. This is in part due to the harsh environment that faces the geophysical engineer. Not only are there significant wind, tidal and weather forces to contend with, but the vastness of the world's oceans raises immense technical difficulties as well. For example, it is easy for a pilot to become disoriented and fatigued, especially when flying at low levels above the water.

With aircraft there are typically difficulties with both land and sea recovery. Many aircraft require a stretch of flat land from which to launch, for example by being towed or held by a level vehicle until sufficient speed is generated to create the necessary lift, and a relatively soft area in which to land. The typical presence of precipitation and wind in a marine environment exacerbates the problem. For these and other reasons, there has been a need for oceanographic geomagnetic surveys, but the cost and danger of such has severely curtailed the number of such surveys.

While oceanographic surveys face a harsh environment, they do not generally require terrain following capabilities. By contrast, for many land based surveys, there is a need for terrain following at low altitude. Such so-called “draping” surveys are difficult to implement using maimed aircraft because of the danger it places upon the pilot, particularly at low elevations.

Unmanned airborne vehicles (UAVs) are well known in the art and have been developed for various uses. U.S. Pat. No. 6,742,741 issued to Rivoli describes a particular unmanned airborne design. However, UAVs have not hitherto been used to acquire aeromagnetic data. UAVs typically have a number of radiation sources that would swamp the sensitive readings of magnetic anomalies. While such interference could be compensated for solely by shielding all electrical equipment, this would greatly increase the cost and weight of the UAV and may interfere with its flight characteristics.

Furthermore, most UAVs are controlled by line of sight (LoS) communications, which thus requires the remote operator to be near the region being overflown, and raises the known human factor concerns. Moreover, many UAVs are unable to provide terrain following capabilities because of the number of waypoints that must be programmed into the navigation system.

What is needed therefore is an autonomous, precise system for acquiring aeromagnetic data over water for geophysical surveying which reduces the both the costs and risks associated with acquiring aeromagnetic data using conventional methods.

What is also needed is an autonomous, precise system for providing terrain-following capability in an unmanned airborne vehicle.

### SUMMARY OF THE INVENTION

Accordingly, the present invention seeks to provide a UAV for aeromagnetic data acquisition, which reduces costs and facilitates the mapping of remote areas. The UAV of the present invention allows for ultra-low level surveying while eliminating risks to flight personnel.

The present invention provides a UAV for acquiring high-quality aeromagnetic data for geophysical surveying in either an off-shore environment, or over complex terrain at low altitudes. The UAV comprises a main magnetometer, a magnetic compensation magnetometer and a data acquisition system connected to both the main and the magnetic compensation magnetometer.

The main magnetometer detects and measures magnetic anomalies as the UAV flies over an area for which a geophysical survey is required and the magnetic compensation magnetometer measures the magnetic data corresponding to the pitch, yaw and roll of the UAV while in operation. The data acquisition system collects and stores the magnetic anomaly measurements as well as the magnetic data corresponding to the pitch, yaw and roll measurements and adjusts for the magnetic effects of the UAV on the magnetic anomaly measurements by subtracting the magnetic data corresponding to the UAVs' pitch, yaw and roll from the magnetic anomaly measurements. The data acquisition system also stores navigation information, which is used to control the flight path of the UAV. The main magnetometer and the magnetic compensation magnetometer are each housed within the fuselage of the UAV and are each spaced apart from the avionics and propulsion systems to reduce the interference from magnetic emissions generated by the avionics and propulsion systems.

The fuselage of the UAV is elongated to increase the spacing of the first and the second magnetometers from the propulsion and avionics systems. Preferably, the magnetometers are housed in the fuselage extension.

The main magnetometer may be mounted within a fully-direction-adjustable mounting within the fuselage of the UAV so that the main magnetometer is rigidly affixed to the UAV when it is operational, but may be adjustable to any desired spatial orientation when the UAV is not in operation, such as during pre-flight checkout.

The generator is shielded to absorb magnetic emissions and reduce magnetic interference reaching the magnetometer.

The electrical wiring of the UAV is adapted to reduce current loops generated by the wires in order to minimize electrical fields that can cause interference with the operations of the magnetometers. In still another embodiment of the invention, the propulsion system may be mounted so that it is stabilized so as to minimize any magnetic interference generated by vibration of the propulsion system.

The main magnetometer may be either a Cesium-vapour magnetometer, an optically pumped type magnetometer, an Overhauser-effect, a proton-precession magnetometer, or a three-axis magnetometer. Preferably, when the main magnetometer is a three-axis magnetometer, it is a three-axis fluxgate magnetometer.

The navigation information stored in the data acquisition system comprises a vehicle flight plan sequentially listing a series of locations identifiable by each of a horizontal and a vertical coordinate relative to pre-selected geographic coordinates, the horizontal coordinate having mutually perpendicular first and second components within a horizontal plane, and the vertical coordinate being perpendicular to the horizontal plane. Preferably the navigation information may be transmitted to the navigation system of the avionics system in real time. Alternatively, the series of locations may be sequentially transmitted to the navigation system. More preferably, the series of locations define a terrain-following path for the UAV.

The UAV may be adapted to be used with a portable launch and recovery system. The UAV may be adapted to be recovered without landing, or it may be adapted to be recovered by an arresting wire. Preferably, the recovery system engages the arresting wire located on a wing of the UAV.

The UAV may be adapted for oceanic flight and/or may be adapted to be launched from a watercraft. The UAV may be adapted to be recovered aboard a watercraft.

The UAV may include a communication system housed in a wingtip of a wing of the UAV for transmitting the magnetic anomaly measures to a remote location.

The UAV may comprise a radar altimeter for measuring the altitude of the vehicle, operatively coupled to the data acquisition system for receiving and storing the altitude measurements from the radar altimeter and more preferably the data acquisition system modifies the navigation information using the radar altimeter measurements so as to prevent the vehicle from flying into terrain or trees. Preferably, the data acquisition system modifies the vehicle flight plan using the radar altimeter measurements to prevent the vehicle from crashing into ground-based obstacles such as trees and/or to improve the terrain-following path of the vehicle.

The advantages of the present invention include that it reduces both the cost of acquiring geophysical survey data and the risk to flight personnel; it is fully autonomous (including during flights offshore); and it is capable of storing large flight plan files. The UAV of the present invention is mobile, and may be used in conjunction with a portable launch and recovery system.

A still further advantage of the UAV of the present invention is that it can provide extensive mapping of large areas, to complement manned surveys, and to direct the attention of expensive personnel and manned aircraft to the most promising areas.

Additionally, the UAV of the present invention has superior maneuverability to manned aircraft, is capable of flying closer to the terrain than manned aircraft, and is therefore capable of taking on high-risk missions, and does not encounter the dangers of fatigue and boredom experienced by pilots on long manned missions.

In one aspect the present invention seeks to provide, an unmanned airborne vehicle for geophysical surveillance of an area including a fuselage, a generator to provide electrical power to the vehicle's systems, a propulsion system and an avionics system having a navigation system, further comprising:
a first magnetometer oriented to detect and measure magnetic anomalies in an area;
a second magnetometer for measuring magnetic response corresponding to pitch, yaw and roll of the vehicle; and
a data acquisition system operatively coupled to the first and the second magnetometers for storing the magnetic anomaly measurements and magnetic response corresponding to the pitch, yaw and roll measurements and for removing the magnetic response measurements from the magnetic anomaly measurements;
the data acquisition system being operatively coupled to the avionics system for transmitting navigation information stored in the data acquisition system for controlling a flight path of the vehicle;
   wherein
the fuselage is adapted to house the first and the second magnetometers; and
the first and the second magnetometers are spaced apart from the propulsion and avionics systems so as to reduce any magnetic interference therefrom.

### BRIEF DESCRIPTION OF THE DRAWINGS

The embodiments of the present invention will now be described by reference to the following figures, in which identical reference numerals in different figures indicate identical elements and in which:

FIG. 1 is a front perspective view of the UAV in accordance with an embodiment of the invention;

FIG. 2 is a block diagram of selected components of the UAV of FIG. 1.

### DETAILED DESCRIPTION OF THE PREFERRED EMBODIMENTS

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

Throughout the description, only the UAV components pertinent to the present invention are discussed. However, it is understood that the UAV of the present invention includes all other components that are required for a UAV to be operational and that a person of ordinary skill in the relevant art would readily know how to select those according to the intended use.

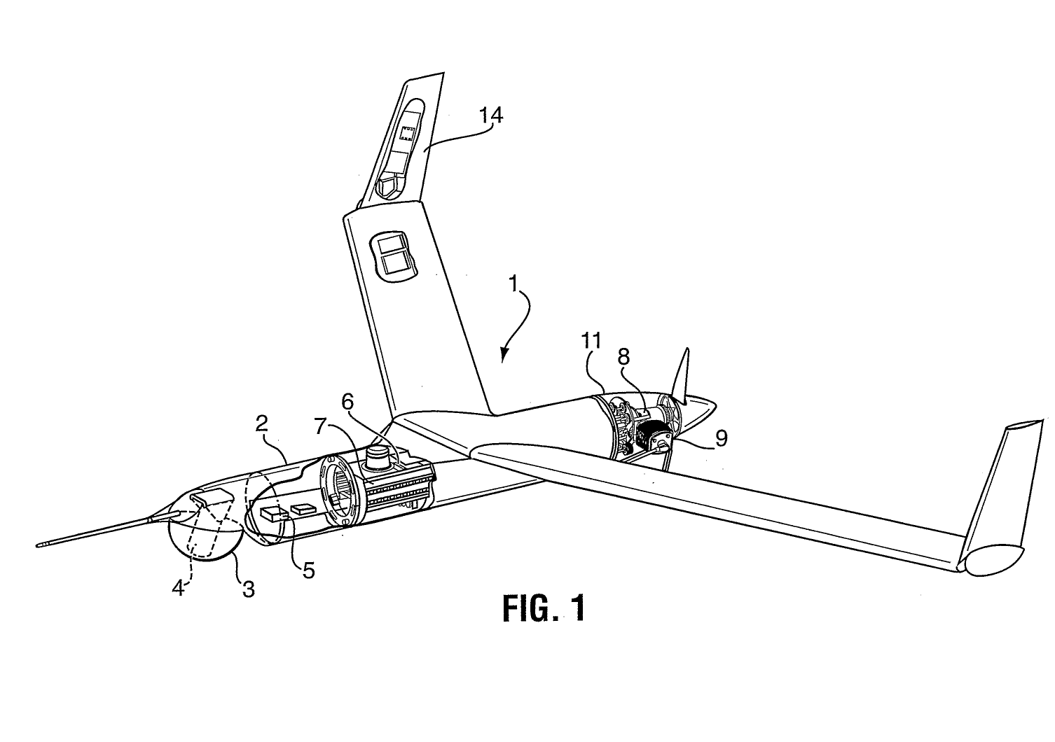

Referring to FIG. 1, a UAV 1 according to a preferred embodiment of the present invention is shown. The UAV 1 has a length of 1.91 m, a wingspan of approximately 3.1 m, and a fuselage diameter of 0.17 m. The UAV 1 is capable of flying at speeds of up to 36 m/s and has a cruising speed of 25 m/s. The service ceiling of the UAV 1 is 5000 m and it may be operated for up to 15 hours without refueling. The empty weight of the UAV 1 is 12 kg, its maximum fuel capacity is 5.5 kg and its maximum takeoff weight is 18 kg. Those having ordinary skill in the relevant art will readily recognize that all dimensions set out herein are only exemplary and that other dimensions will readily be substituted without departing from the spirit and the scope of the invention.

The UAV 1 includes a fuselage extension 2, a data acquisition system 7, and a number of noise and vibration reducing elements.

The fuselage extension 2 of the UAV 1 of the present invention is extended forward and aft of the UAV's 1 centre of gravity by 35 cm in each direction. The extension in both directions minimizes the impact of the extension on the flight characteristics of the UAV 1. The aft section of the fuselage 2 is extended to lengthen the fuel tank so that the UAV's 1 range may be increased, so that it is more suitable for geophysical survey purposes. A magnetometer mount 3, at a distance of approximately 61 cm from the centre line of the UAV 1 is preferably installed within the nose area of the fuselage extension 2.

The magnetometer mount 3 is constructed so that the main magnetometer 4 is rigidly fixed to the fuselage when the UAV 1 is in operation. The magnetometer mount 3 may also be constructed so that it is movable to any desired spatial orientation during pre-flight of the UAV 1 in order that the main magnetometer 4 may be properly oriented when in flight over the survey area. In the preferred embodiment of the invention, the main magnetometer 4 is mounted in a fully articulated mount, such as a 16.5 cm styrofoam ball, which is drilled out to accommodate the main magnetometer 4. The ball may be rotated into any attitude appropriate for maximum magnetic sensitivity during flight operation, and fixed in place before operation of the UAV 1 commences.

Both the main magnetometer 4 and the magnetic compensation magnetometer 5 are designed to have small outer dimensions so that they may neatly fit within the fuselage extension 2, and the main magnetometer 4 may be mounted neatly within a 16.5 cm styrofoam ball.

The main magnetometer 4 is preferably an optically-pumped cesium vapour magnetometer manufactured by Scintrex under model number CS3L. However, the main magnetometer 4 may be any suitable magnetometer such as an optically pumped type magnetometer, an Overhauser-effect magnetometer, a proton-precession magnetometer, a three-axis magnetometer or three-axis fluxgate magnetometer.

At a distance of approximately 35.5 cm from the centre of gravity of the UAV 1, a magnetic compensation magnetometer 5 is installed. The magnetic compensation magnetometer 5 is preferably a three-axis Fluxgate magnetometer, and is used for measuring the pitch, yaw and roll of the UAV 1. More preferably, the three-axis Fluxgate magnetometer is manufactured by Billingsley Magnetics. The magnetic compensation magnetometer 5 is installed within the fuselage extension 2 on a fixed platform (not shown).

The forward section of the fuselage extension 2 also includes a radar altimeter, such as those manufactured by Roke, installed at a distance of approximately 25 cm from the centre of gravity of the UAV 1.

The data acquisition system 6 is located in the avionics bay in proximity to the UAV's conventional avionics system 7, at a distance of approximately 9 cm forward of the centre of gravity. The separation of the data acquisition system 6 is thus 0.5 m from the main magnetometer 4, which has been found to be sufficient to reduce its magnetic noise signature and thus the interference it might cause with the readings of the main magnetometer 4. The data acquisition system 6 interfaces with a dual frequency GPS (not shown) of the UAV 1 and the avionics system 7 in order to obtain accurate positional data with which to correlate the main magnetometer data 4. The data acquisition system 6 conveniently provides power to the main magnetometer 4 and the magnetic compensation magnetometer 5.

The data acquisition system 6 is programmed with a flight plan used by the UAV 1 to fly a survey pattern. The flight plan consists of a sequential list of a series of locations that are identifiable by each of a horizontal and a vertical coordinate relative to pre-selected geographic coordinates, based on the three dimensional x, y, z coordinate system. The horizontal coordinate has mutually perpendicular x and y components within a horizontal plane. The vertical coordinate has a z component that is perpendicular to the horizontal plane. Preferably, the flight plan comprises long parallel sweeps in a direction in which the magnetic sensitivity of the main magnetometer 4 is at a maximum, and shorter segments connecting pairs of sweeps at their extremities. However, it will be readily apparent to a person of ordinary skill in the relevant art that other known flight plans may be used for geophysical surveying.

The data acquisition system 6 stores survey path vertical and horizontal coordinates from the GPS and the avionics system 7, and either periodically or in real-time, supplies flight path information in-flight to the navigation system (not shown) of the UAV 1.

The avionics system 7 includes an autopilot system (not shown), which enables the UAV 1 to follow the flight plan received from the data acquisition system 6, either sequentially or in real time, so as to fly long straight legs at a low altitude over an area to be surveyed. The autopilot system (not shown) is sufficiently accurate so as to allow the UAV 1 to stay within 1 meter of each path defined by the series of locations of the flight plan, which is sufficient for geophysical survey purposes. Preferably, the data acquisition system adjusts the series of locations of the vehicle flight plan as the UAV overflies a survey area based on the altitude measurements obtained from the radar altimeter in order to prevent the vehicle from flying into terrain or trees and to improve the terrain-following path of the UAV 1. More preferably, the data acquisition stores the vehicle flight plan with the adjusted series of locations for future surveys.

It should be noted that the closer that the main magnetometer 4 and the magnet compensation magnetometer 5 are to conventional moving or radiating parts in the UAV 1, such as the propulsion system 8, or other electromagnetic devices in the UAV 1, such as the generator 9, the noisier that the measurements received from the main magnetometer 4 will be. If the distance between these radiating parts and the magnetometers 4, 5, in the extended fuselage 2 is sufficient, shielding may be appropriate. For example, to reduce the noise reaching the main magnetometer 4, the generator 9 is shielded to absorb magnetic emissions therefrom. The generator 9 is shielded using is a closed-ended cylinder having approximate dimensions 7.5 cm long by 4 cm diameter. Preferably, the closed-ended cylinder is manufactured from metal. More preferably, the metal is a high-susceptibility, magnetically soft metal, such as Co-Netic™ metal from Magnetic Shield Corporation.

To reduce vibrations generated by the propulsion system, the present invention uses engine mounts 11 to stabilize the propulsion system within the UAV 1. In traditional UAVs, the engine mounts 11 comprise a system of shock absorbers that stabilize the propulsion system when the UAV 1 is operated. In the present invention, the system of shock absorbers are stiffened to minimize vibrational frequencies generated by the movement of the engine mount 11 during UAV 1 operation that may cause interference with the readings of the main magnetometer 4.

To further reduce noise reaching the main magnetometer 4, the electrical wiring of the UAV 1 maybe modified to reduce current loops to minimize electrical fields created by the wiring. The electrical fields are reduced by removing ground-return wires interconnecting the electrical systems (not shown) of the UAV 1, and by bringing the positive and negative wires used to interconnect the electrical systems (not shown) of the UAV 1 into close proximity with one other. Preferably, the positive and negative wires are run as twisted pairs.

Experiments have shown that by shielding the generator 9, stabilizing the propulsion system, re-configuring the wiring and by subtracting any response caused by the UAV 1 motion from the magnetic anomaly measurement as discussed below, the UAV 1 of the present invention allows for magnetic anomaly measurements to be taken with noise levels of well below 1 nT.

The UAV 1 of the present invention may further include a communications system located in the wingtips 14 of the UAV 1. The winglet 14 houses antennas for communication with a remote ground station. The communication system allows for real-time communication of the survey measurements from the data acquisition system 7 to a remote ground station. For beyond line-of-sight operation, an Iridium satellite communication radio may be installed in the winglet 14 for transmitting the survey measurements. In either configuration, the flight plan may be optionally transmitted to the data acquisition system 7 in real-time using the communication system in the winglets 14.

Typically UAVs are configured for sea and land-based operations. UAVs have in the past been launched from land using either a car or truck-based launch system, or launched from a catapult located on a watercraft.

The UAV 1 of the present invention is preferably launched from any land based location or onboard any suitable watercraft using the pneumatic SuperWedge™ launcher system developed by Insitu Corporation. The launch acceleration is approximately 12 Gs, and launch velocity is approximately 27 m/s, at an angle between 12° and 25° above the horizon. The Superwedge™ launcher may be deployed on land, i.e. the launcher may be wheeled, or mounted on a vehicle, or it may be affixed to a watercraft. Those being of ordinary skill in the relevant art will readily recognize that other suitable launch systems may equally be used to launch the UAV 1 of the present invention.

To recover the UAV 1, the navigation system may be programmed to return the UAV 1 to the launch location or to a remote area such as an open field to avoid ground-based obstacles such as trees.

The UAV 1 of the present invention preferably includes a hook (not shown) located on either wingtip 14 of the UAV 1. This permits the UAV 1 to be retrieved using the Skyhook™ retrieval system developed by Insitu Corporation. The UAV 1 flies under self control in accordance with its flight plan into a vertical wire stretched vertically 13.5 m from the Skyhook™ retrieval system. As the UAV 1 approaches the retrieval system under direction from the data acquisition system 6, the hook catches the vertical wire. The hook stops and retains the UAV 1, and once the UAV 1 has been captured, the avionics system disengages the propulsion system 8. The positioning of the UAV 1 relative to the retrieval system is done by differential GPS between the UAV 1 and a GPS receiver on the Skyhook™ retrieval system, and is accurate down to one centimetre. It should be noted that the Skyhook™ retrieval system itself may be deployed on a trailer, or attached to a watercraft and may share a platform with the launch system, resulting in an extremely portable and self-contained system.

The UAV 1 of the present invention is preferably manufactured of a graphite composite material and the winglets 14 are preferably manufactured using fiberglass to strengthen the whole UAV 1 structure while minimizing its weight.

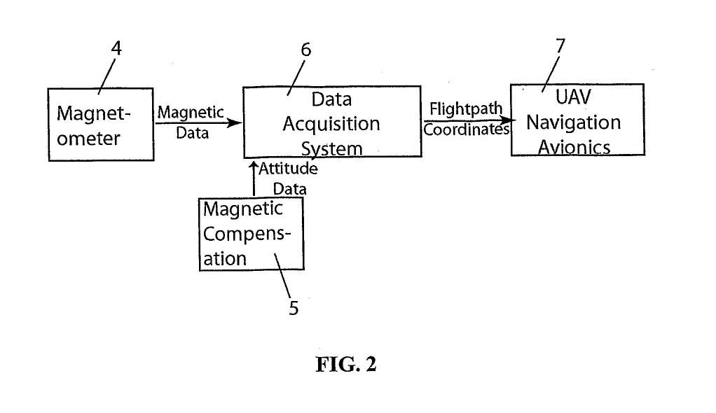

Referring to FIG. 2, a block diagram of selected components of the UAV 1 of FIG. 1 is shown. FIG. 2 shows the main magnetometer 4 and the magnetic compensation magnetometer 5 each being connected to the data acquisition system 6. The data acquisition system 6 in turn is connected to the avionics system 7.

In operation, the UAV 1 of the present invention is launched from a SuperWedge™ launcher system. During pre-flight operations, the magnetometer mount 3 is oriented to maximize the main magnetometer 4 sensitivity in the primary direction of the long sweeps in the survey's pre-programmed flight path.

After launching the UAV 1, as the vehicle gains altitude and speed, the data acquisition system 6 transmits a survey flight plan to the navigation system (not shown) of the avionics system 7 and initiates the recording of magnetic anomaly measurements and the magnetic data corresponding to the pitch, yaw and roll measurements from the main magnetometer 4 and the magnetic compensation magnetometer 5 respectively. For the majority of the flight path, the magnetometer 4 is oriented to maximize its magnetic sensitivity.

As the UAV 1 overflies the survey flight plan, the magnetometer 4 detects and measures magnetic anomalies in the area. As the UAV 1 overflies the survey area, the motion of the UAV 1 within the primary geomagnetic field of the Earth causes currents to flow within the structure of the UAV 1, creating magnetic fields that mask those that are to be measured by the main magnetometer. These magnetic fields, referred to herein as magnetic maneuver noise, must be separated from the magnetic anomaly measurements in order to have an accurate survey of an area.

To obtain measurements for the magnetic maneuver noise, the magnetic compensation magnetometer 5 measures magnetic data corresponding to the pitch, roll and yaw motions of the UAV 1 as the UAV flies the flight plan. While the UAV 1 flies according to the flight plan, the magnetic anomaly measurements and the magnetic data corresponding to pitch, roll and yaw measurements are recorded and stored by the data acquisition system 6 which uses computer software to compare the magnetic data corresponding to pitch, yaw and roll measurements to the changing response from the main magnetometer 4, and to subtract any response caused strictly by the UAV 1 motion from the magnetic anomaly measurements.

In one particular embodiment of the invention, the data acquisition system 6 also receives altitude measurements from the radar altimeter during UAV 1 flight and adjusts the flight plan of the UAV 1 to avoid crashing into ground-based obstacles such as the Earth's terrain, debris thereon, or trees. In still another embodiment of the invention, the data acquisition system 6 may adjust the stored flight plan with the altitude measurements so that future surveys may be flown without incident.

Once the flight plan has been completed, the UAV 1 is directed by the flight plan to return to a recovery site, which may be a specific land or sea location near the launch site. The UAV 1 approaches the Skyhook™ retrieval system, where it is retrieved in the manner described above. Alternatively, the UAV 1 may be allowed to land on flat open terrain.

It should be understood that the preferred embodiments mentioned here are merely illustrative of the present invention. Numerous variations in design and use of the present invention may be contemplated in view of the following claims without straying from the intended scope and field of the invention herein disclosed.

What is claimed is:

1. An unmanned airborne vehicle for geophysical surveillance of an area including a navigation system adapted to store a plurality of waypoints to be traversed, the vehicle comprising:
a first magnetometer oriented to detect and measure magnetic anomalies in the area;
a second magnetometer for measuring magnetic response corresponding to pitch, yaw and roll of the vehicle;
a data acquisition system operatively coupled to the first and the second magnetometers for storing the magnetic anomaly measurements and magnetic response corresponding to the pitch, yaw and roll measurements and for removing the magnetic response measurements from the magnetic anomaly measurements; and
the data acquisition system maintaining therewithin a vehicle flight plan sequentially listing a series of coordinates and adapted to transmit at least one coordinate to the navigation system to update the plurality of waypoints.

2. An unmanned airborne vehicle according to claim 1, wherein the orientation of the first magnetometer may be rotated relative to the UAV orientation.

3. An unmanned airborne vehicle according to claim 1, further comprising a mounting rotatably secured to the fuselage and constructed and arranged to secure the first magnetometer.

4. An unmanned airborne vehicle according to claim 1, wherein the first and second magnetometers are housed in a nose area of the vehicle.

5. An unmanned airborne vehicle according to claim 1, wherein the first magnetometer is selected from one member of the group consisting of a Cesium-vapour proton-precession magnetometer, an optically pumped type proton-precession magnetometer, an Overhauser-effect proton-precession magnetometer, a 3-axis magnetometer and a 3-axis fluxgate magnetometer.

6. An unmanned airborne vehicle according to claim 1, wherein the second magnetometer is a 3-axis fluxgate magnetometer.

7. An unmanned airborne vehicle according to claim 1, wherein each coordinate comprises a pair of mutually perpendicular first and second components within a horizontal plane.

8. An unmanned airborne vehicle according to claim 7, wherein each coordinate comprises a vertical coordinate perpendicular to the horizontal plane.

9. An unmanned airborne vehicle according to claim 7, wherein the vehicle follows a flight path that is a constant altitude above terrain features of the area.

10. An unmanned airborne vehicle according to claim 1, further comprising a radar altimeter for measuring the altitude of the vehicle.

11. An unmanned airborne vehicle according to claim 10, wherein the radar altimeter is operatively coupled to the data acquisition system, the data acquisition system receiving and storing the altitude measurements from the radar altimeter.

12. An unmanned airborne vehicle according to claim 11, wherein the data acquisition system uses the altitude measurements to adjust the flight path to prevent contact with a ground-based obstacle.

13. An unmanned airborne vehicle according to claim 11, wherein the data acquisition system uses the altitude measurements to adjust the flight path to maintain the vehicle a fixed altitude above terrain features of the area.

14. An unmanned airborne vehicle according to claim 10, wherein the data acquisition system stores the altitude measurements from the radar altimeter.

15. An unmanned airborne vehicle according to claim 1, wherein the data acquisition system transmits the at least one coordinate in real-time to the navigation system.

16. An unmanned airborne vehicle according to claim 1, wherein the data acquisition system transmits the at least one coordinate periodically to the navigation system.

17. An unmanned airborne vehicle according to claim 1, further comprising a communication subsystem.

18. An unmanned airborne vehicle according to claim 17, whereby coordinate information may be transmitted from a ground station to the data acquisition system via the communication subsystem.

19. An unmanned airborne vehicle according to claim 17, whereby magnetic anomaly measurements may be transmitted to a ground station via the communication subsystem.

20. An unmanned airborne vehicle according to claim 17, wherein the communication subsystem is housed in a wingtip of the vehicle.

21. An unmanned airborne vehicle according to claim 17, wherein the communication subsystem is housed in a fuselage of the vehicle.

22. An unmanned airborne vehicle according to claim 17, wherein the communication subsystem comprises an antenna, whereby coordinate information may be transmitted from the ground station to the navigation system by line of sight communication.

23. An unmanned airborne vehicle according to claim 17, wherein the communication subsystem comprises a satellite radio, whereby coordinate information may be transmitted from the ground station to the navigation system when the vehicle is outside the ground station's line of sight.

24. An unmanned airborne vehicle according to claim 1, wherein the vehicle is adapted to be launched from a launch system.

25. An unmanned airborne vehicle according to claim 22, wherein the launch system is stationary.

26. An unmanned airborne vehicle according to claim 25, wherein the launch system is a catapult.

27. An unmanned airborne vehicle according to claim 24, wherein the launch system is mobile.

28. An unmanned airborne vehicle according to claim 1, wherein the vehicle is adapted to be recovered by an arresting wire.

29. An unmanned airborne vehicle according to claim 28, wherein the vehicle engages the arresting wire along a wing attached to a fuselage of the vehicle.

30. An unmanned airborne vehicle according to claim 1, wherein the vehicle is adapted for oceanic flight.

31. An unmanned airborne vehicle according to claim 30, wherein the vehicle is adapted to be launched from a watercraft.

32. An unmanned airborne vehicle according to claim 30, wherein the vehicle is adapted to be recovered aboard a watercraft.

33. An unmanned airborne vehicle according to claim 1, further comprising a fuselage adapted to house the first and second magnetometers.

34. An unmanned airborne vehicle according to claim 33, wherein the fuselage is elongated to increase the spacing of the first and second magnetometers from a propulsion system.

35. An unmanned airborne vehicle according to claim 34, wherein the spacing of the first and second magnetometers from the propulsion system is a minimum of 1 m.

36. An unmanned airborne vehicle according to claim 1, wherein the propulsion system is stabilized to reduce any vibratory emissions therefrom.

37. An unmanned airborne vehicle according to claim 33, wherein the fuselage is elongated to increase the spacing of the first and second magnetometers from an avionics system.

38. An unmanned airborne vehicle according to claim 37, wherein the spacing of the first and second magnetometers from the avionics system is a minimum of 0.5 m.

39. An unmanned airborne vehicle according to claim 1, further comprising a generator to provide electrical power to the vehicle, wherein the generator is shielded to reduce any magnetic or electrical emissions therefrom.

40. An unmanned airborne vehicle according to claim 39, wherein the generator is shielded using a closed-end cylinder.

41. An unmanned airborne vehicle according to claim 40, wherein the closed-end cylinder is composed of a high-susceptibility, magnetically soft metal.
